(19) United States
(12) Patent Application Publication
(10) Pub. No.: US 2017/0140309 A1
(43) Pub. Date: May 18, 2017

(54) DATABASE ANALYSIS DEVICE AND DATABASE ANALYSIS METHOD

(71) Applicant: HITACHI, LTD., Tokyo (JP)

(72) Inventors: Yasunori HASHIMOTO, Tokyo (JP); Ryota MIBE, Tokyo (JP); Hirofumi DANNO, Tokyo (JP); Katsumi KAWAI, Tokyo (JP); Keishi OOSHIMA, Tokyo (JP); Kiyoshi YAMAGUCHI, Tokyo (JP); Makoto KIMURA, Tokyo (JP)

(73) Assignee: HITACHI, LTD., Tokyo (JP)

(21) Appl. No.: 15/344,698

(22) Filed: Nov. 7, 2016

(30) Foreign Application Priority Data
Nov. 13, 2015 (JP) 2015-222591

(51) Int. Cl. G06Q 10/06; G06F 17/30

(52) U.S. Cl. CPC G06Q 10/0633; G06F 17/30312; G06F 17/30548

(57) ABSTRACT

An attribute having influence on a business flow is automatically extracted among one or more attributes associated with the business flow when the business flow is restored based on history data of business performed on a business system. An event sequence variation indicating an order of an attribute name is calculated based on a chronological relation of an attribute value of a date and time from history data of the business configured with an attribute name and an attribute value of business, the number of appearances of each attribute value of each attribute other than a date and time is counted for each event sequence variation, event sequences that are similar in a distribution of the number of appearances are grouped, and business flows generated for respective groups are integrated.

### CLAIM OF PRIORITY

The present application claims priority from Japanese application serial no. JP 2015-222591, filed on Nov. 13, 2015, the content of which is hereby incorporated by reference into this application.

### TECHNICAL FIELD

The present invention relates to a database analysis device and a database analysis method.

### BACKGROUND ART

As a background art of a technical field of the present invention, a technique of automatically extracting a characteristic point through a relation between a business flow and an attribute value of a specific attribute associated with the business flow when the business flow is restored based on history data of business performed on a business system is disclosed in Patent Document 1.

### SUMMARY OF THE INVENTION

### Problems to be Solved by the Invention

However, in the technique of restoring the business flow disclosed in JP 2010-20577 A (Patent Document 1), it is necessary for a user to designate an attribute corresponding to a “specific attribute” in the history data in advance, and when a specification of the history data is not clear, it is difficult to designate an attribute in advance.

For example, when the business flow is restored from database data of an enterprise system, the number of attributes included in one table of the database mostly exceeds 100, and thus it is difficult for the user to know an attribute having influence on the business flow among the attributes in advance.

### SOLUTIONS TO PROBLEMS

In order to solve the above problem, for example, configurations set forth in claims are employed. The present disclosure includes a plurality of configurations for solving the above problem, but for example, provided is a database analysis method of receiving history data of business for a business system stored in a database and analyzing a flow of the business, wherein the history data of the business is table data configured with an attribute name and an attribute value of the business, and the database analysis method includes an event sequence calculation step of calculating an event sequence variation indicating an order of the attribute name based on a chronological relation of an attribute value of a date and time from the input history data of the business, an attribute value appearance frequency counting step of counting the number of appearances of each attribute value of each attribute other than a date and time for each calculated event sequence variation, an event sequence grouping step of comparing distributions of the counted number of appearances of the event sequence variations and bringing event sequences having a similar distribution into the same group, a business flow generation step of generating a business flow by integrating the event sequences of the same group and generating the entire business flow by integrating generated business flows of different groups, and a business flow output step of outputting the entire business flow.

### EFFECTS OF THE INVENTION

According to the present invention, it is possible to automatically extract an attribute having influence on the business flow among one or more attributes associated with the business flow when the business flow is restored based on history data stored in a database of business performed on a business system. Accordingly, the user can extract an attribute having influence on the business flow without knowing a specification related to history data used for restoration of the business flow.

### BRIEF DESCRIPTION OF THE DRAWINGS

FIG. 1 is an example of a configuration diagram of a database analysis device;

FIG. 2 is an example of a flowchart for describing a process of a database analysis device;

FIG. 3 is an example of a conceptual diagram of data which is set as an analysis target by a database analysis device;

FIG. 4 is an example of a conceptual diagram for describing a process of calculating a generated event sequence variation based on analysis target data;

FIG. 5 is an example of a conceptual diagram for describing a process of counting the number of appearances of an attribute value for each generated event sequence variation;

FIG. 6 is an example of a conceptual diagram for describing a process of comparing distributions of the number of appearances of attribute values of generated event sequence variations;

FIG. 7 is an example of a conceptual diagram for describing a process of determining similarity of distributions of the number of appearances of attribute values;

FIG. 8 is an example of a conceptual diagram for describing a process of integrating generated event sequences classified into the same group;

FIG. 9 is an example of a conceptual diagram for describing a process of integrating business flows of different groups; and

FIG. 10 is an example of a conceptual diagram for describing an analysis result.

### MODE FOR CARRYING OUT THE INVENTION

Hereinafter, exemplary embodiments will be described with reference to the appended drawings.

### First Embodiment

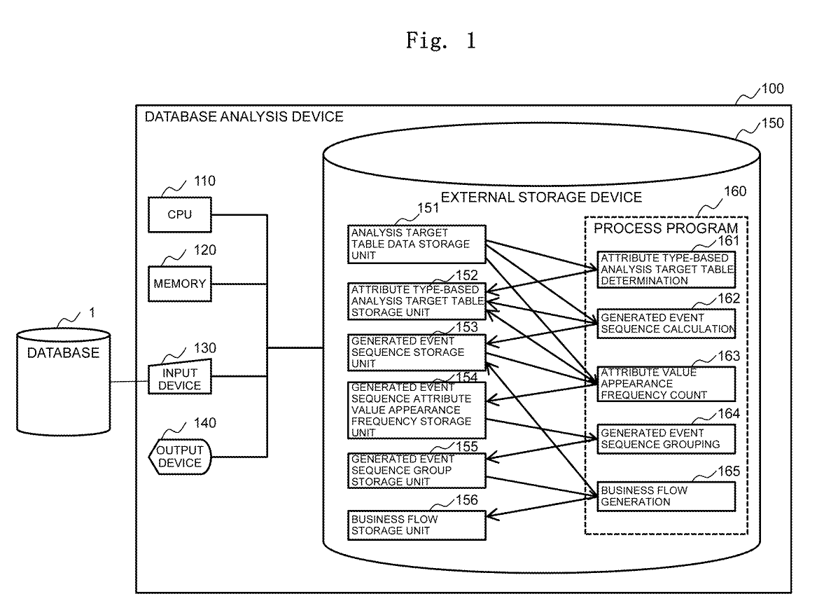

In the present embodiment, an example of a database analysis device will be described. FIG. 1 is an example of a configuration diagram of a database analysis device according to the present embodiment.

A database analysis device 100 includes a CPU 110, a memory 120, an input device 130, an output device 140, and an external storage device 150. The external storage device 150 stores an analysis target table data storage unit 151, an attribute type-based analysis target table storage unit 152, a generated event sequence storage unit 153, a generated event sequence attribute value appearance frequency storage unit 154, a generated event sequence group storage unit 155, and a business flow storage unit 156, and further stores an attribute type-based analysis target table determination 161, a generated event sequence calculation 162, an attribute value appearance frequency count 163, a generated event sequence grouping 164, and a business flow generation 165 as a process program 160. At the time of execution, the process program 160 is read out to the memory 120 and executed by the CPU 110. A database 1 stores history data of business in a business system.

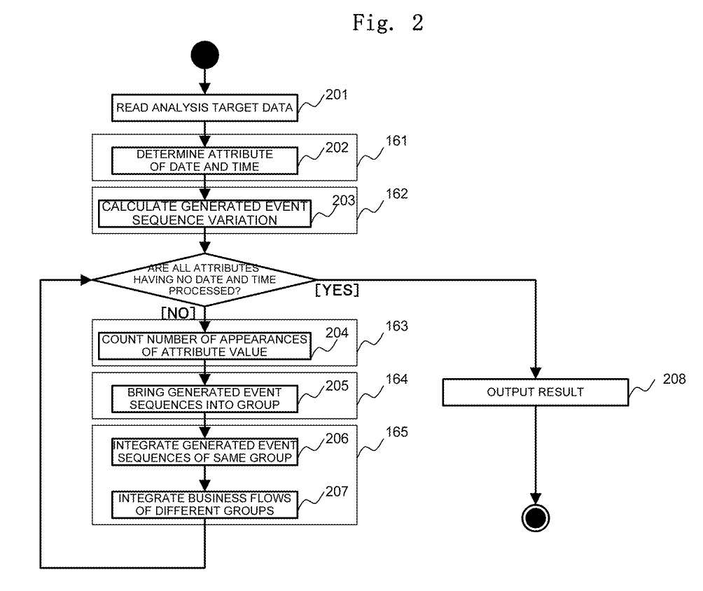

Operations of the respective components illustrated in FIG. 1 will be described with reference to FIG. 2.

FIG. 2 is an example of a flowchart for describing a process of the database analysis device according to the present embodiment. Step 201 is a step of inputting data of the database 1 which is analyzed by the database analysis device. An input operation is performed by the user of the device. In step 201, among the data of the database 1 input from the outside through the input device 130, data corresponding to one table is written in the analysis target table data storage unit 151.

In the present embodiment, a case in which a single table is analyzed will be described. When a plurality of tables are analyzed, the tables are joined and gathered as one table, or the tables may be individually analyzed.

In the present embodiment, a process of analyzing data of a table format of a relational database will be described, but for example, any other format of data such as log data including an event name and a time stamp as an attribute may be dealt with as long as data indicates a history of business.

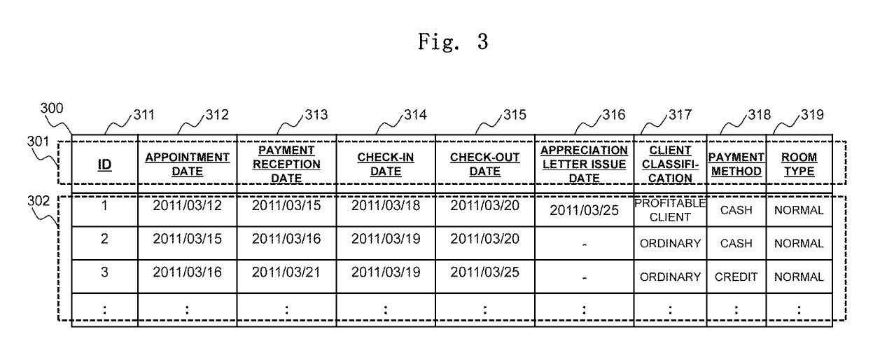

FIG. 3 is an example of a conceptual diagram of data which is set as an analysis target by the database analysis device according to the present embodiment. Data serving as the analysis target of the database analysis device has a format corresponding to one table and is classified into a plurality of attributes. Each attribute is classified into an attribute name 301 and an attribute value 302. In the present embodiment, the analysis target data includes nine attributes such as an ID 311, an appointment date 312, a payment reception date 313, a check-in date 314, a check-out date 315, an appreciation letter issue date 316, a client classification 317, a payment method 318, and a room type 319, and the ID 311 among them is assumed to be a primary key. Further, when an attribute serving as the primary key is unclear, a unique number is allocated to each record and used as an alternative of the primary key.

A process of steps 202 to 207 to be described below is a mechanical process based on input information and can be performed only by the database analysis device with no manual intervention.

In step 202, the CPU 110 that has read the program of the attribute type-based analysis target table determination 161 determines whether or not each attribute of data indicates a date and time with reference to the data of the database read from the analysis target table data storage unit 151, and writes a determination result in the attribute type-based analysis target table storage unit 152.

A process of determining whether or not a certain attribute is data indicating a date and time may be implemented by calculating a degree in which a format of a value of the attribute matches a format of a date and time (YYYY/MM/DD, YYYY-MM-DD, or the like) through a pattern matching unit or the like.

Practically, there are various cases such as a case in which there is only a value of a date and time, a case in which there is only a value of a date, and a case in which a date and a time are separate attributes, but in the present embodiment, for the sake of simplicity, the description will proceed with an example in which only a value of a date is indicated by a YYYY/MM/DD format.

In the present embodiment, all of five attributes of the appointment date 312, the payment reception date 313, the check-in date 314, the check-out date 315, and the appreciation letter issue date 316 have a value of the YYYY/MM/DD format and are thus determined to have a value of a date and time. Further, three attributes of the client classification 317, the payment method 318, and the room type 319 are determined to be an attribute having no value of a date and time. The ID 311 serving as the primary key may not undergo the determination process of the present step.

In step 203, the CPU 110 that has read the generated event sequence calculation 162 extract an attribute value of a date and time from the data of the database read from the analysis target table data storage unit 151 with reference to the attribute type-based analysis target table storage unit 152, calculates a variation of a chronological order relation of the attribute value, and writes a result in the generated event sequence storage unit 153 as a generated event sequence variation.

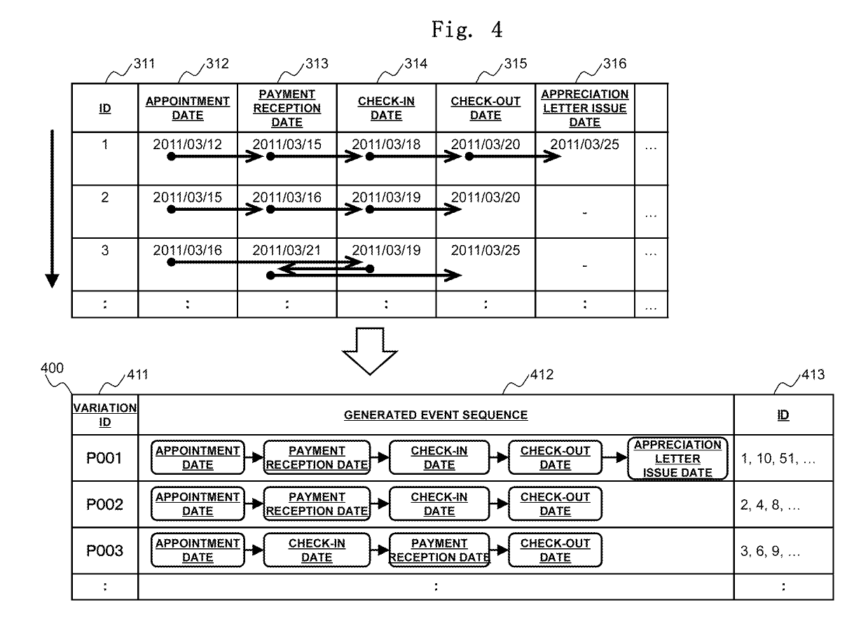

FIG. 4 is an example of a conceptual diagram for describing a process of calculating the generated event sequence variation based on the analysis target data according to the present embodiment. In the present step, the chronological order relation is calculated by comparing values of the attributes 312 to 316 determined to be an attribute of a date and time for records of an analysis target data table 300. Further, attribute names are sorted based on the calculated order relation and written in a generated event sequence variation table 400 as a generated event sequence 412 indicating an order of the attribute name. At this time, as a variation ID 411 of the generated event sequence variation table 400, a character string specific to the generated event sequence 412 is input. A value of the ID 311 related to a record of the analysis target data corresponding to the generated event sequence 412 is added to the ID 413. The present process is performed on all the records of the analysis target data table 300, the generated event sequence variation table 400 which is generated is written in the generated event sequence storage unit 153, and step 203 is completed.

Then, a process of steps 204 to 207 is performed on all the attributes having no date and time among the data of the database included in the analysis target table data storage unit 151. When the process on all the attributes having no date and time is completed, the process proceeds to step 208.

In step 204, the CPU 110 that has read the program of the attribute value appearance frequency count 163 selects one or more of the attributes having no date and time from the data of the database read from the analysis target table data storage unit 151 with reference to the attribute type-based analysis target table storage unit 152, calculates the number of appearances of the value of the attribute for each generated event sequence variation read from the generated event sequence storage unit 153, and writes the number of appearances of the value of the attribute in the generated event sequence attribute value appearance frequency storage unit 154.

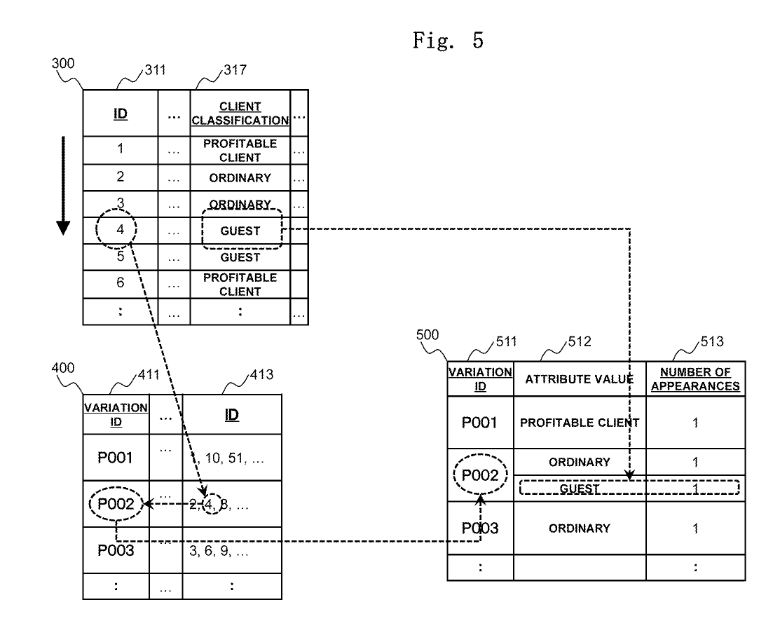

FIG. 5 is an example of a conceptual diagram for describing a process of counting the number of appearances of the attribute value for each generated event sequence variation according to the present embodiment. Here, a process of selecting the client classification 317 as the attribute having no date and time and counting the number of appearances of the value will be described. The CPU 110 that has read the program of the attribute value appearance frequency count 163 extract the value of the variation ID 411 corresponding to the ID 311 serving as the primary key based on information of the generated event sequence variation table 400 for each record of the analysis target data table 300. Further, in the generated event sequence variation attribute value appearance frequency table 500, a value of the number of appearances 513 in which the value of the extracted variation ID 411 is a value of a variation ID 511, and a value of the client classification 317 is a value of an attribute value 512 is increased. The present process is performed on all the records of the analysis target data table 300, the resulting generated event sequence variation attribute value appearance frequency table 500 is written in the generated event sequence attribute value appearance frequency storage unit 154, and step 204 is completed.

Further, when a numerical value is considered to have a meaning, for example, when a value of a selected attribute is a numerical value, the attribute value may be quantized by any method. For example, a numerical value of 30 to 39 is converted into a category such as “30's” and dealt with.

In step 205, the CPU 110 that has read the program of the generated event sequence grouping 164 compares the number of appearances of the attribute values of the generated event sequence variations read from the generated event sequence attribute value appearance frequency storage unit 154, brings the generated event sequence variations which are similar in the distribution of the number of appearances into the same group, and writes a result in the generated event sequence group storage unit 155.

Further, when a plurality of groups are extracted in the present step, it indicates that the generated event sequence is changed by the value of the selected attribute, and the attribute can be determined to have on the business flow. On the other hand, when all the event sequences are brought into a single group, the value of the attribute does not make a contribution to a change in the generated event sequence and thus can be determined not to have influence on the business flow. When the selected attribute is determined not to have influence on the business flow, subsequent steps 206 and 207 may not be performed on the selected attribute.

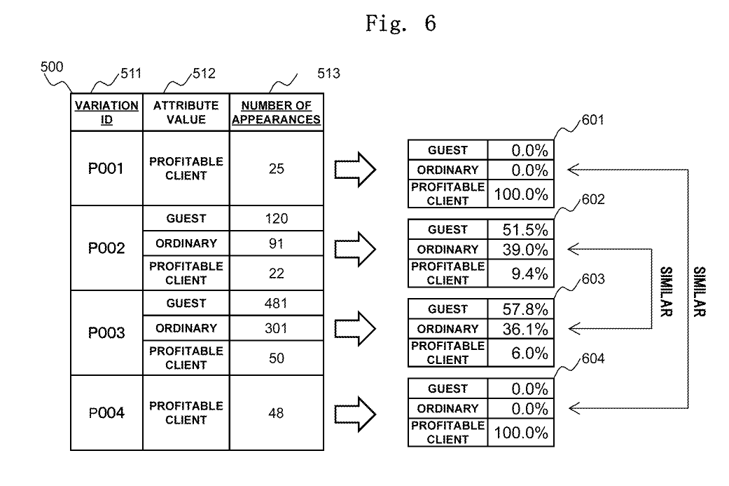

FIG. 6 is an example of a conceptual diagram for describing a process of comparing the distributions of the number of appearances of the attribute values of the generated event sequence variations according to the present embodiment. Attribute value appearance rates 601 to 604 of the variation IDs with reference to the attribute value 512 and the number of appearances 513 of the variation ID 511 in the generated event sequence variation attribute value appearance frequency table 500. Further, a degree of similarity of the appearance rates is determined, and the appearance rates 601 and 604 and the appearance rates 602 and 603 which are determined to be similar to each other are brought into the same group.

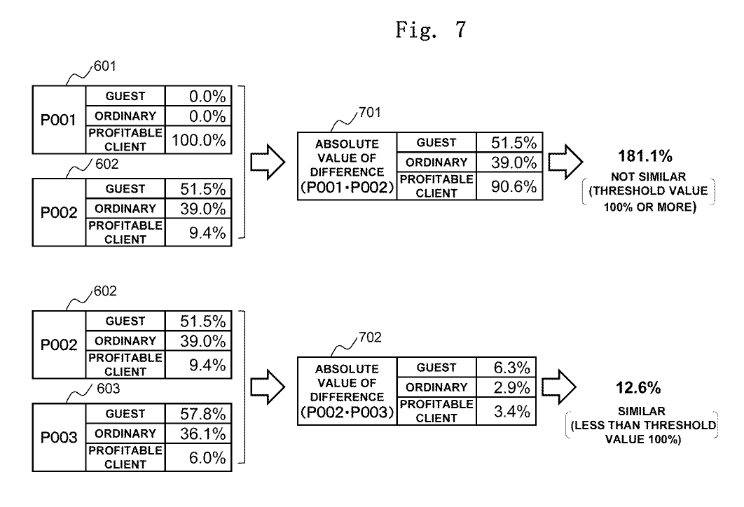

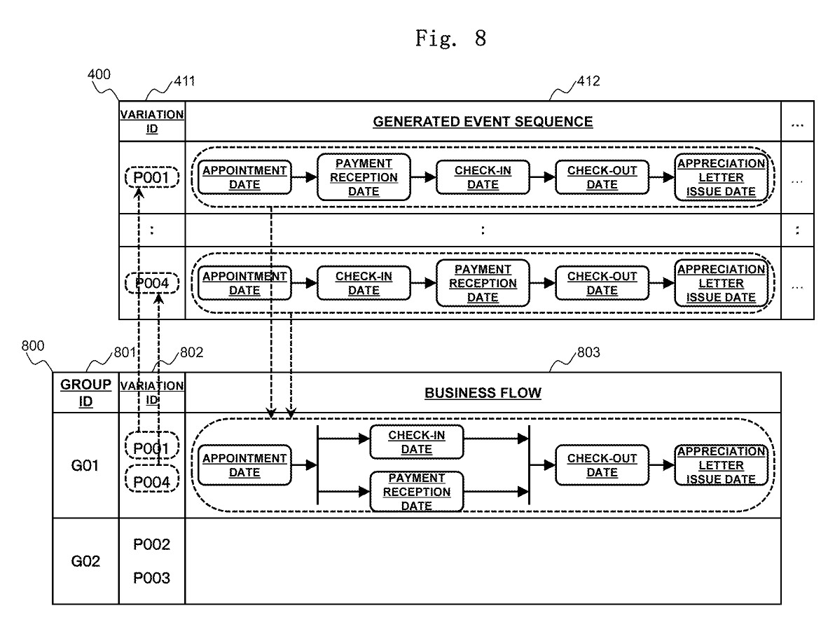

FIG. 7 is an example of a conceptual diagram for describing a process of determining similarity of the distributions of the number of appearances of the attribute values according to the present embodiment. Various methods are considered as a method of determining a degree of similarity of the appearance rates of the attribute values, but a method of making determination by comparing an absolute value of a difference between the appearance rates of both attribute values with a threshold value is here illustrated. A sum of absolute values 701 of differences between the appearance rates calculated from the number of appearances 601 and 602 of the attribute values is 181.1% and larger than a threshold value 100% in the present embodiment. In this case, a difference between the distributions is large, and thus it is determined that there is no similarity. Further, a sum of absolute values 702 of differences between the appearance rates calculated from the number of appearances 602 and 603 of the attribute values is 12.6% and smaller than a threshold value 100% in the present embodiment. In this case, a difference between the distributions is small, and thus it is determined that there is a similarity. In step 206, the CPU 110 that has read the program of the business flow generation 165 reads the same group of the generated event sequence variation from the generated event sequence group storage unit 155, generates the business flow in which the generated event sequences classified into the same group are integrated, and writes the generated business flow in the business flow storage unit 156. FIG. 8 is an example of a conceptual diagram for describing a process of integrating the generated event sequences classified into the same group according to the present embodiment. The CPU 110 that has read the program of the business flow generation 165 selects one of groups extracted in a previous step, and inputs the variation IDs of the event sequences classified into the same group into a variation ID 802 of a group-based business flow table 800. Further, the generated event sequence 412 extract the generated event sequence 412 corresponding to the variation ID with reference to the generated event sequence variation table 400, generates a group-based business flow 803 based on the extracted generated event sequence 412, and registers the group-based business flow 803 in a business flow 803. A character string specific to the variation ID 802 is allocated to the group ID 801.

There are various methods of generating the group-based business flow 803 based on the generated event sequence 412, but as an example, there is a method of generating a business flow in which the event sequences are overlapped, and differences therebetween are expressed as processes to be executed in parallel. In FIG. 8, since the “check-in date” and the “payment reception date” are different in a generated order in an original generated event sequence, a business flow in which the “check-in date” and the “payment reception date” are expressed as processes to be executed in parallel, and other common events are left is generated. Further, when the differences are expressed as processes to be executed in parallel, if an event that is not present in any of the event sequences is included, the event is expressed as an arbitrary process event.

In step 207, the CPU 110 that has read the program of the business flow generation 165 causes results of step 206 for the respective groups to overlap, generates a business flow in which difference therebetween are regarded as branches by the selected attribute values, and writes the generated business flow in the business flow storage unit 156.

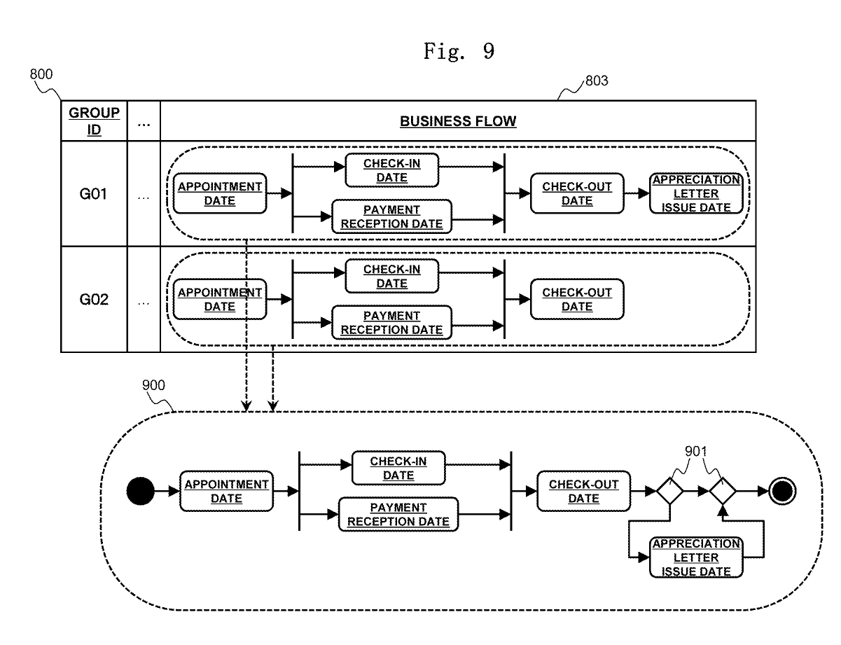

FIG. 9 is an example of a conceptual diagram for describing a process of integrating business flows of different groups according to the present embodiment. The CPU 110 that has read the program of the business flow generation 165 causes all business flows stored in the group-based business flow 803 to overlap, generates the entire business flow 900 expressed such that differences between business flows are connected by branches 901, associates the selected attribute name with the business flow, and then writes resulting data in the business flow storage unit 156.

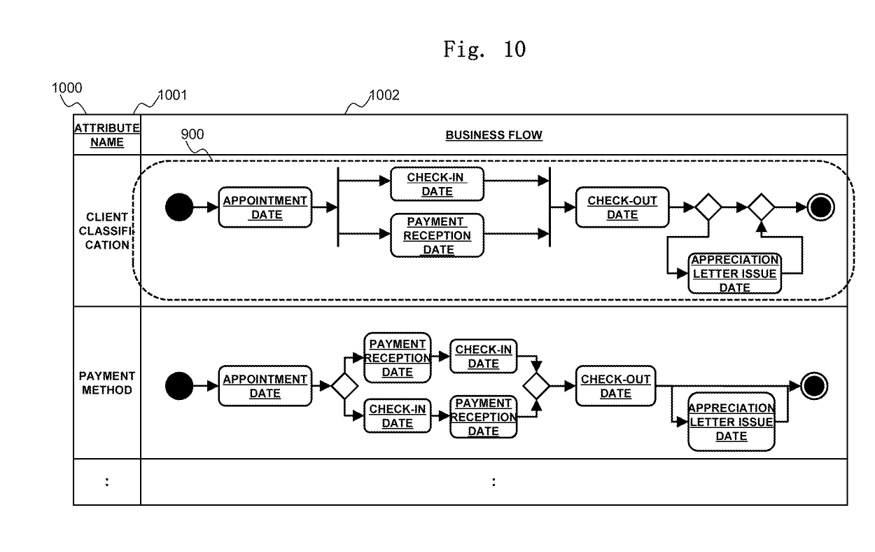

FIG. 10 is an example of a conceptual diagram for describing an analysis result according to the present embodiment. The database analysis device stores an attribute-based business flow 1000 serving as an analysis result in the business flow storage unit 156. The attribute-based business flow 1000 includes a set of an attribute name 1001 and a business flow 1002 of an attribute having no date and time. By checking content of the attribute name 1001, even the user who does not know a specification related to the history date used for restoration of the business flow can extract an attribute having on influence on the business flow. Further, by checking content of the business flow 1002 of each attribute name 1001, it is possible to compare effects of the attributes on the business flow. Step 208 is a step in which the database analysis device 100 outputs the analysis result obtained by the device through the output device 140. Information of the business flow written in the business flow storage unit 156 is output to the output device 140 according to an instruction of the user input from the input device 130. Further, text data or binary data that is processed by a computer may be output, and characters or graphics may be displayed on a monitor so that the user of the device can view them.

1. A database analysis method of receiving history data of business for a business system stored in a database and analyzing a flow of the business,
the history data of the business being table data configured with an attribute name and an attribute value of the business, the method comprising:
an event sequence calculation step of calculating an event sequence variation indicating an order of the attribute name based on a chronological relation of an attribute value of a date and time from the input history data of the business;
an attribute value appearance frequency counting step of counting the number of appearances of each attribute value of each attribute other than a date and time for each calculated event sequence variation;
an event sequence grouping step of comparing distributions of the counted number of appearances of the event sequence variations and bringing event sequences having a similar distribution into the same group;
a business flow generation step of generating a business flow by integrating the event sequences of the same group and generating the entire business flow by integrating generated business flows of different groups; and
a business flow output step of outputting the entire business flow.

2. The database analysis method according to claim 1,
wherein the entire business flow generated in the business flow generation step is a business flow in which different portions between the business flows of the different groups which are integrated are indicated as branches.

3. The database analysis method according to claim 2,
wherein in the business flow output step, a plurality of types of business flows having different branches are output.

4. The database analysis method according to claim 1,
wherein the event sequence grouping step includes calculating appearance rates of attribute values based on the counted number of appearances, comparing a difference of the appearance rate between the event sequence variations, and determining that the event sequence variations have a similar distribution when the difference is smaller than a predetermined threshold value.

5. The database analysis method according to claim 1,
wherein in the attribute value appearance frequency counting step, when an attribute value other than a date and time is a numerical value, categorizing is performed.

6. A database analysis device, comprising:
an input unit that receives history data of business for a business system stored in a database;
a central processing unit (CPU); and
an output unit,
wherein the history data of the business is table data configured with an attribute name and an attribute value of the business,
the CPU executes
an event sequence calculation of calculating an event sequence variation indicating an order of the attribute name based on a chronological relation of an attribute value of a date and time from the history data of the business received by the input unit,
an attribute value appearance frequency counting of counting the number of appearances of each attribute value of each attribute other than a date and time for each of a plurality of calculated event sequence variation;
an event sequence grouping of comparing distributions of the counted number of appearances of the event sequence variations and bringing event sequences having a similar distribution into the same group; and
a business flow generation of generating a business flow by integrating the event sequences of the same group and generating the entire business flow by integrating generated business flows of different groups;
the output unit outputs the entire business flow.
